(19) United States
(12) Patent Application Publication
(10) Pub. No.: US 2006/0085104 A1
(43) Pub. Date: Apr. 20, 2006

(54) Speed controller of an electrical car

(75) Inventors: Ta-Min Peng, Taoyuan County (TW); Sheng-Yu Tai, Pingjhen City (TW)

Correspondence Address: C.Q.S. Electrical Products Inc., P. O. Box No. 6-57, Junghe, Taipei, 235, TW

(73) Assignee: C.Q.S. Eelectrical Products Inc., Pingjhen city (TW)

(21) Appl. No.: 10/965,758

(22) Filed: Oct. 18, 2004

(51) Int. Cl. G06F 17/00

(52) U.S. Cl. 701/22; 180/65.3

(57) ABSTRACT

A speed controller of an electrical car includes a fin emplaced on the base plate of a body, a control circuit board and a drive circuit board connected and emplaced on the top of the fin, and separated by a support bracket. Moreover, an external signal input terminal is located on the body, to facilitate the feeding of external control signal into the control circuit board and the transmission of feedback signal and control signal. For the control circuit, the direction and strength of current of a motor winding are controlled by transistors, and the magnitude of current strength of a motor armature winding is controlled by transistors, using the PWM method. The magnitude of current strength is acquired by a feedback resistor and passed to a CPU, serving as the basis of controlling the direction of current of the motor field winding and the motor speed.

### BACKGROUND OF THE INVENTION

a) Field of the Invention

The present invention relates to a speed controller of an electrical car, and more particularly to a speed controller wherein a fin is located on a base plate of a body, with a control circuit board and a drive circuit board located on the top of the fin and separated by a support bracket, and an external signal input terminal is located on the body and is connected with a connecting terminal on the control circuit board via a junction, thereby facilitating the feeding of external control signal into the control circuit board, and facilitating the transmission of feedback signal and control signal via the connection of the connecting terminal of the control circuit board with the connecting terminal of the drive circuit board.

b) Description of the Prior Art

For conventional motor speed control, the rotation speed is generally controlled by input voltage or current. However, it cannot accurately control the rotation speed of a motor merely by controlling the strength of voltage or current, and the continuous increase or decrease of the voltage or current of a motor armature and field winding will easily cause the overheating and vibration of the coils of the motor, and the increase of circuit loss, thereby lowering the lifetime of a motor.

### SUMMARY OF THE INVENTION

The primary object of the present invention is to provide a speed controller of an electrical car. A shown in FIG. 5 and FIG. 6, a controller A is connected with a motor G, with an output terminal C2 of field winding of a drive circuit connected with a motor field winding E. The direction and strength of the current of the motor field winding E is changed via transistors Q1, Q2, Q3, and Q4. The magnitude of current strength is acquired through resistors R1 and R2 and passed to a CPU (Central Processing Unit) B2, serving as the basis of controlling the direction of current of the motor field winding E.

Accordingly, an output terminal C1 of an armature winding is connected with a motor armature F, with the current strength of the motor armature F controlled by a transistor Q5, using the PWM (Pulse Width Modulation) method. The magnitude of the current strength is acquired by a feedback resistor D and passed to a CPU B2, serving as the basis of speed controlling.

Accordingly, to emphasize the advancement and practicability of the present invention, the comparison with the conventional controller is provided below:

Shortcoming of the conventional controller

Motor speed control is unstable.

It cannot accurately control the motor speed.

Control of the current of motor armature winding and field winding is limited.

Advantage of the present invention

The direction of field winding current is controllable, thereby facilitating the control of rotation direction of motor.

The strength of armature winding current is controllable, thereby facilitating the control of rotation speed of motor.

The accuracy of control can be increased through circuit and feedback resistor.

It has advancement and practicability.

It can increase industrial competitiveness.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a front view of the present invention.

FIG. 2 shows a rear view of the present invention.

FIG. 3 shows a schematic view of the structure of the present invention.

FIG. 4 shows a schematic view of the composition for the present invention.

FIG. 5 shows a schematic view of the drive circuit.

FIG. 6 shows a schematic view of the implementation for the present invention.

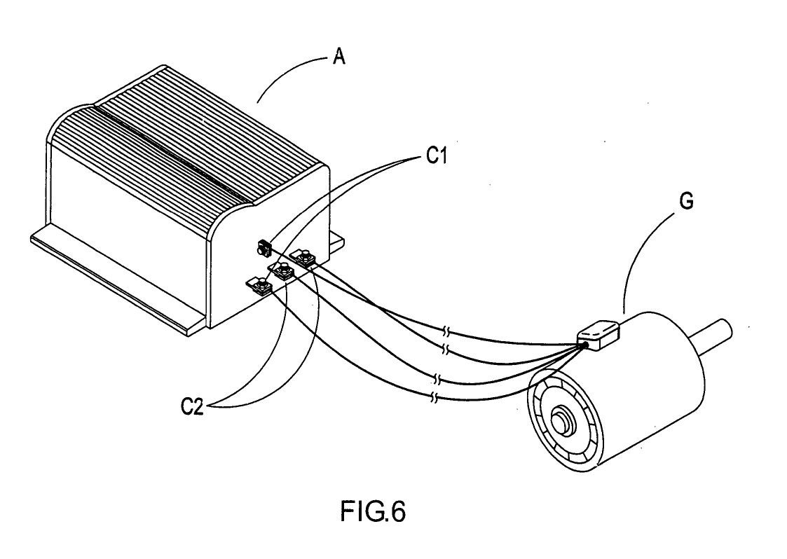

### DETAILED DESCRIPTION OF THE PREFERRED EMBODIMENTS

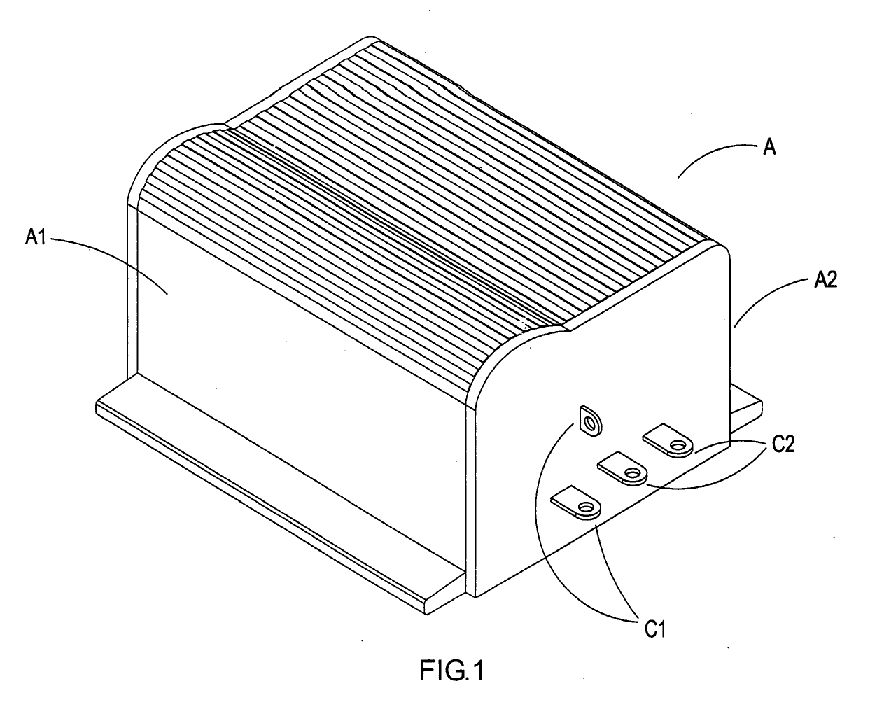

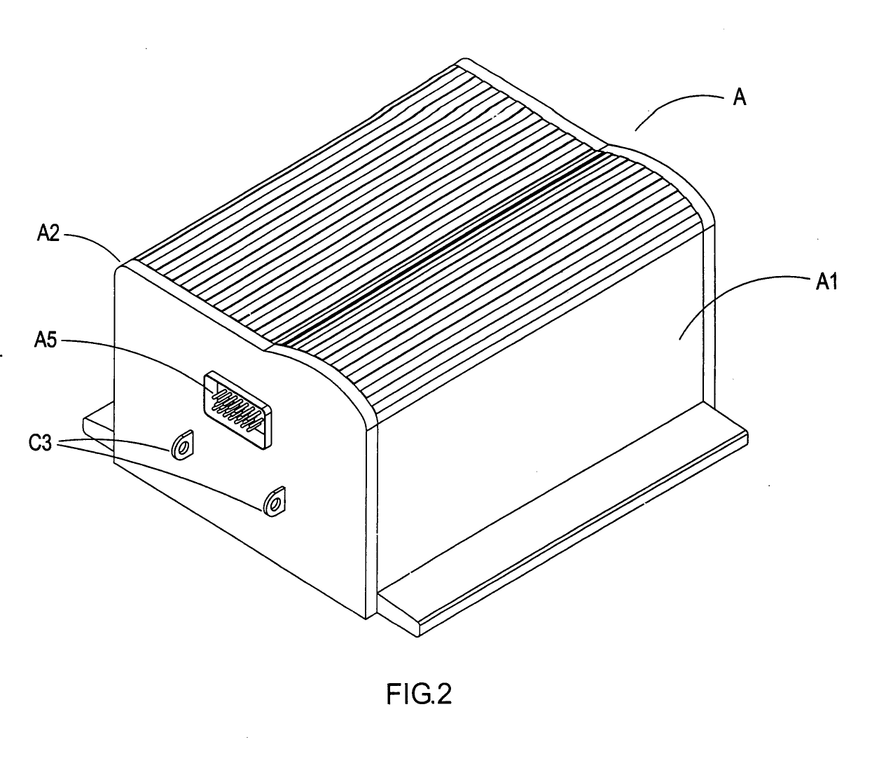

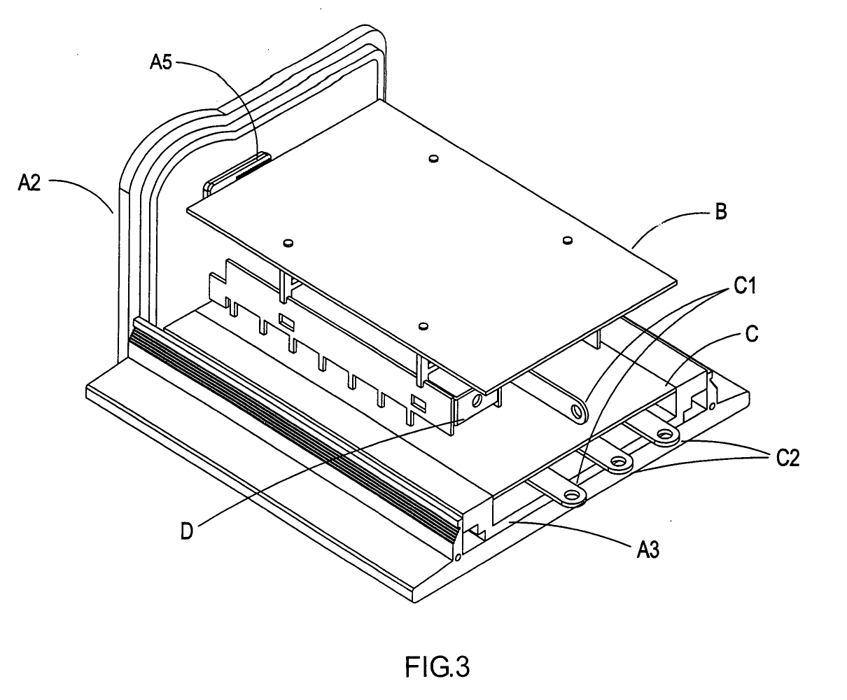

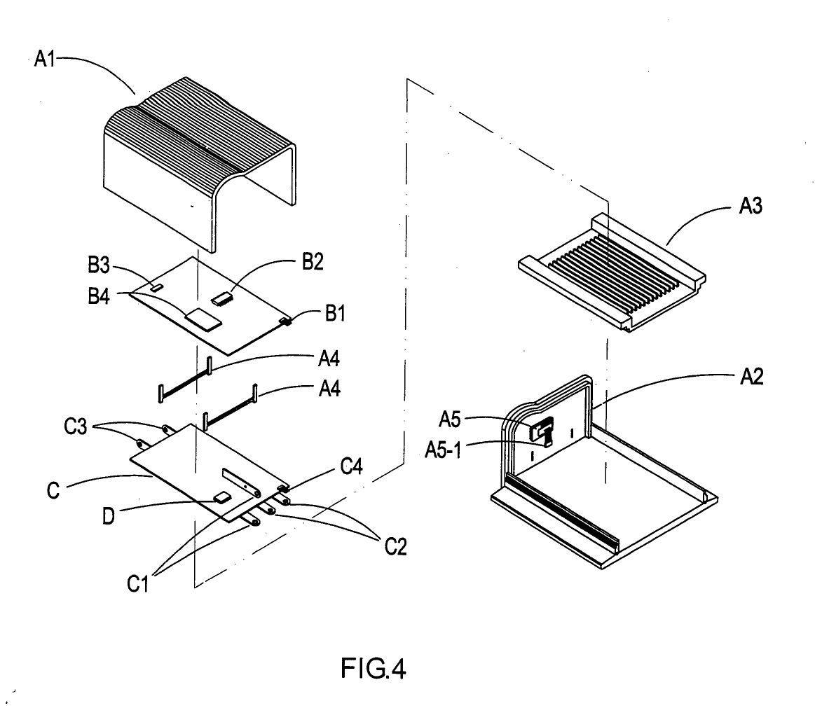

Referring to FIG. 1, FIG. 2, FIG. 3, and FIG. 4, the present invention comprises primarily a controller A, which consists of a casing A1, a body A2, a fin A3, a support bracket A4, a control circuit board B, and a drive circuit board C. The control circuit board is equipped with two connecting terminals B1, and B3, a CPU B2, and a control circuit B4, whereas the drive circuit board B is equipped with a armature winding output terminal C1, a field winding output terminal C2, a power input terminal C3, a connecting terminal C4, and a feedback resistor D.

Accordingly, after emplacing the fin A3 at the base plate of the body A2, the control circuit board B and the drive circuit board C are emplaced at the top of the fin A3, and separated by the support bracket A4. Moreover, an external signal input terminal A5 is located on the body A2, and is connected with the connecting terminal B3 of the control circuit board via a junction A5-1, thereby facilitating the feeding of external control signal into the control circuit board B, and facilitating the transmission of feedback signal and control signal via the connection of the connecting terminal B1 of the control circuit board B with the connecting terminal C4 of the drive circuit board.

Accordingly, the fin A3 can be used to expel the heat dissipated during the functioning of electric circuits, and can be made of aluminum, copper, and other material used as fins for expelling the heat energy generated by electronic/electrical components.

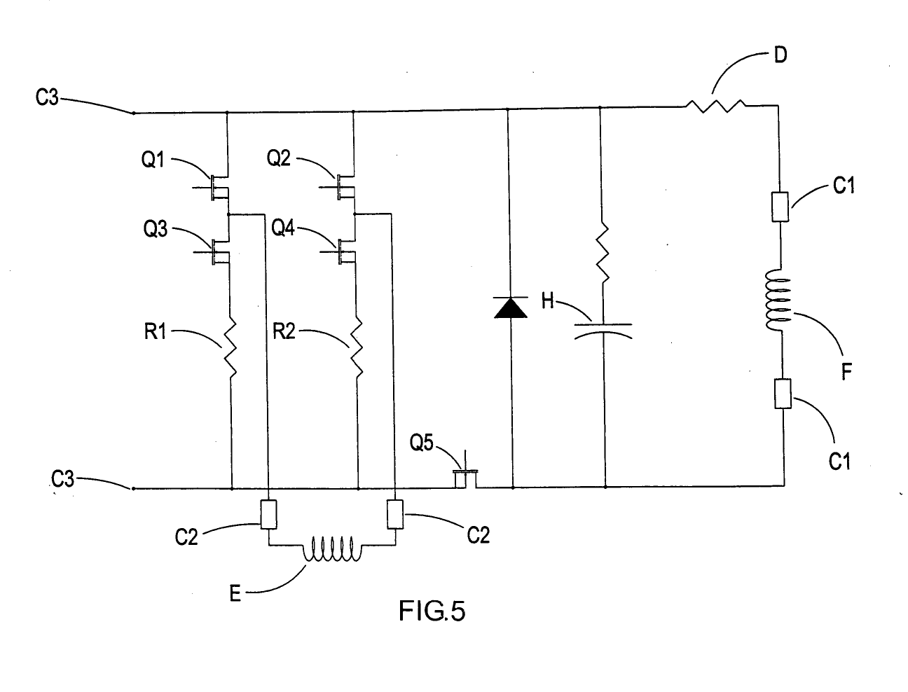

Referring to FIG. 4 and FIG. 5, the field winding output terminal C2 of the drive circuit is connected with a motor field winding E, with is direction and strength of current controlled by four transistors Q1, Q2, Q3, and Q4. The magnitude of current strength is acquired by resistors R1 and R2 and passed to the CPU B2 to serve as the basis of controlling the direction of current of the motor field winding E.

Accordingly, the armature winding output terminal C1 is connected with the motor armature winding F, whose strength of current is controlled by a transistor Q5, using the PWM (Pulse Width Modulation) method. The magnitude of current strength is acquired by the feedback resistor D and passed to the CPU B2, to serve as the basis of speed control. Moreover, all the electrical signals, including the strength of field winding current, the strength of armature winding current, the temperature of fin, the rotation speed of motor, the voltage of battery are transmitted to the CPU B2. In addition, after the CPU B2 has accessed the feedback signal and referred to the input signal of the external signal input terminal, the transistors Q1, Q2, Q3, and Q4 will calculate the adequate control signal to control the motor winding E and the motor armature winding F. On the other hand, to avoid the surge generated during the startup of motor F or the change of forward-reverse rotating, a surge absorber is formed through a capacitor H and a resistor R3, to absorb the surge generated by the motor F, thereby avoiding the burnout of circuits caused by the surge current.

Accordingly, the transistors can be of FET (Field-Effect Transistor), MOS (Metal Oxide Semiconductor), BJT (Bipolar Junction Transistor), IGBT (Insulated Gate Bipolar Transistor), or transistors of other related electronic circuits.

Accordingly, the feedback resistor can be of phosphor bronze resistor, cement resistor, carbon film resistor, or resistors of other related power resistors used in electronic/electric applications.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A speed controller of an electrical car, primarily comprising a casing, a body, a fin, a support bracket, a control circuit board, and a drive circuit board, with connecting terminals, CPU and a control circuit located on the control circuit board, and an armature winding output terminal, a field winding output terminal, a power input terminal, a connecting terminal and a feedback resistor located on the drive circuit board; with its feature of emplacing the control circuit board and the drive circuit board on the top of the fin, and separating the control circuit board and the drive circuit board following the emplacement of the fin at the base plate of the body; an external signal input terminal located on the body, connected with the connecting terminal of the control circuit board via a junction, thereby facilitating the feeding of external control signal into the control circuit board, and facilitating the transmission of feedback signal and control signal via the connection of the connecting terminal of the control circuit board with the connecting terminal of the drive circuit board; the field winding output terminal of the drive circuit connected with a motor field winding, with direction and strength of current controlled by transistors; with the magnitude of current strength acquired by resistors and passed to a CPU serving as the basis of controlling the direction of current of the motor field winding; the armature winding output terminal connected with the motor armature winding, with its strength of current controlled by a transistor, using the PWM (Pulse Width Modulation) method, and with the magnitude of current strength acquired by a feedback resistor and passed to the CPU, serving as the basis of speed controlling; and with all the electrical signals, including the strength of field winding current, the strength of armature winding current, the temperature of fin, the rotation speed of motor, the voltage of battery transmitted to the CPU, and, following the feedback signal accessed by the CPU, and the input signal of the external signal input terminal referred by the CPU, the adequate control signal calculated by the transistors to control the motor winding and the motor armature winding;

2. The speed controller of an electrical car according to claim 1, with the CPU of a AVR-Mega processor and other microprocessor of related electronic/electric circuits for automatic control;

3. The speed controller of an electrical car according to claim 1, with the fin made of aluminum, copper, and other material used as fins for expelling the heat energy generated by electronic/electrical components;

4. The speed controller of an electrical car according to claim 1, with the transistors of FET (Field-Effect Transistor), MOS (Metal Oxide Semiconductor), BJT (Bipolar Junction Transistor), IGBT (Insulated Gate Bipolar Transistor), or transistors of other related electronic circuits;

5. The speed controller of an electrical car according to claim 1, with the feedback resistor of phosphor bronze resistor, cement resistor, carbon film resistor, or resistors of other related power resistors used in electronic/electric applications.
